(19) United States
(12) Patent Application Publication
(10) Pub. No.: US 2011/0060868 A1
(43) Pub. Date: Mar. 10, 2011

(54) MULTI-BANK FLASH MEMORY ARCHITECTURE WITH ASSIGNABLE RESOURCES

(75) Inventor: Brent S. Haukness, Monte Sereno, CA (US)

(73) Assignee: RAMBUS INC., Los Altos, CA (US)

(21) Appl. No.: 12/867,882

(22) PCT Filed: Feb. 10, 2009
(86) PCT No.: PCT/US09/33629

§ 371 Date: Sep. 22, 2010

Related U.S. Application Data
(60) Provisional application No. 61/029,858, filed on Feb. 19, 2008.

(51) Int. Cl. G06F 12/00; G06F 12/02

(52) U.S. Cl. 711/103; 711/E12.001; 711/E12.008

(57) ABSTRACT

This disclosure has described embodiments of a nonvolatile memory that includes at least two concurrently accessible memory banks (302), each including nonvolatile memory cells. The nonvolatile memory further includes at least one sharable resource (306), such as a power supply module, a program controller or an erase controller, wherein each sharable resource (306) is assignable to at least two of the concurrently accessible memory banks to enable a first type of memory operation. The nonvolatile memory additionally includes a number of dedicated resources (304), such as read controllers, wherein each dedicated resource (304) is configured to enable a second type of memory operation on a specific bank within the concurrently accessible memory banks.

### TECHNICAL FIELD

The present embodiments generally relate to memory design. More specifically, the present embodiments relate to the design of a multi-bank memory architecture that facilitates independently controlling different banks within a memory to improve memory utilization.

### BRIEF DESCRIPTION OF THE FIGURES

FIG. 1 presents a block diagram illustrating an embodiment of a multi-bank memory architecture.

FIG. 2A illustrates an embodiment of a multi-bank flash memory architecture wherein each memory bank is associated with a dedicated local bank controller.

FIG. 2B illustrates an exemplary integrated circuit (IC) chip floorplan for the multi-bank flash memory architecture illustrated in FIG. 2A.

FIG. 3A illustrates an embodiment of a multi-bank flash memory architecture using both shared control resources and dedicated local bank controller.

FIG. 3B illustrates a variation of the embodiment of the multi-bank flash memory architecture 300 illustrated in FIG. 3A.

FIG. 3C illustrates another variation of the embodiment of the multi-bank flash memory architecture illustrated in FIG. 3A.

FIG. 3D illustrates yet another variation of the embodiment of the multi-bank flash memory architecture illustrated in FIG. 3A.

FIG. 3E illustrates an exemplary IC chip floorplan for the multi-bank flash memory architecture illustrated in FIG. 3D.

FIG. 4A illustrates an embodiment of a multi-bank flash memory architecture using only shared control resources.

FIG. 4B illustrates a variation of the embodiment of multi-bank flash memory architecture illustrated in FIG. 4A.

FIG. 4C illustrates an exemplary IC chip floorplan for the multi-bank flash memory architecture illustrated in FIG. 4B.

FIG. 5 illustrates a flash memory device comprising a given type of assignable control resource and a set of associated memory banks.

FIG. 6 illustrates a multi-bank flash memory architecture using a single controller.

FIG. 7A illustrates the use of fully assignable power supply modules to support a set of memory banks.

FIG. 7B illustrates the use of regional assignable power supply modules to support a set of memory banks.

FIG. 7C illustrates an embodiment which combines the flash memory design of FIG. 3C with separate assignable power supplies.

FIG. 7D illustrates the use of a single assignable power supply module to support a set of memory banks.

### DETAILED DESCRIPTION

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present description. Thus, the present description is not intended to be limited to the embodiments shown, but is to be accorded the widest scope consistent with the principles and features disclosed herein.

### Overview

Advances in semiconductor technology presently make it possible to integrate hundreds of millions of transistors onto a single flash memory chip. These advances have enabled flash memory to become increasingly more affordable and ubiquitous. Of the two common types of flash memory, NAND flash memory facilitates faster reading of large files and more rapid erasing and writing than NOR flash memory, and is therefore well-suited for solid-state storage. Because NAND flash memory also has a much lower cost per bit than other types of memory, it may be desirable to use NAND flash memory in a computer system's main memory.

Unfortunately, NAND flash memory is typically associated with significantly longer write times (˜200-900 μs) as compared to DRAM memory, and requires an even longer erase operation (˜1-2 ms) before flash memory cells can be reprogrammed. These long operation times can greatly limit flash memory device utilization. One solution to this problem is to enable concurrent operations on different banks of a flash memory device to improve device utilization.

For example, in some embodiments, a flash memory device is divided into multiple banks, and the flash memory device is capable of performing reading, programming, or erasing operations to each bank independently. Hence, this type of flash memory device can simultaneously support different memory operations on multiple memory banks. For example, while a time-consuming erase operation is being performed in one bank, program and read operations can be concurrently performed on other banks.

In some embodiments, dedicated local bank controllers are assigned to multiple memory banks, so that each memory bank can be independently controlled by a dedicated read control, a dedicated program control, and a dedicated erase control.

In some embodiments, to enable concurrent and independent bank operations, multiple sharable/assignable bank controllers are used in place of the dedicated local bank controllers. In these embodiments, each sharable/assignable bank controller can be assigned to a subset or all of the memory banks to support a given type of memory operation required by a memory bank. Note that using sharable/assignable bank controllers instead of dedicated local bank controllers can result in significant die size reduction.

In some embodiments, to enable concurrent and independent bank operations, a combination of dedicated local bank controllers and multiple sharable/assignable bank controllers are used. For example, read operations can be handled independently by dedicated local controllers and program and erase operations can be handled by a group of sharable/assignable controllers. In these embodiments, the number of assignable controllers of a given type can be determined based on how many operations of a certain type may be performed simultaneously.

In some embodiments, a global control circuitry can be used to: (1) coordinate the multiple local bank controllers; and (2) determine the assignment of multiple sharable/assignable controllers to memory banks.

In some embodiments, to enable concurrent and independent bank operations, power supplies, charge pump circuits, and other non-controller resources within a multi-bank flash memory device are sharable and assignable to each bank.

Although the aforementioned embodiments are described in the context of a flash memory device, in general the aforementioned embodiments may be used in any type of memory device comprising multiple memory banks or multiple memory regions.

Furthermore, the aforementioned embodiments may be used in any type of computer system or computing device, including: a desktop or laptop computer, a hand-held or portable computing device (such as personal digital assistants, portable media players, and/or cellular telephones), a set-top box, a home network, digital cameras, portable storage devices, and/or a video-game device.

We now describe detailed embodiments for designing multi-bank flash memory devices that support concurrent and independent bank operations.

### A Multi-Bank Memory Architecture

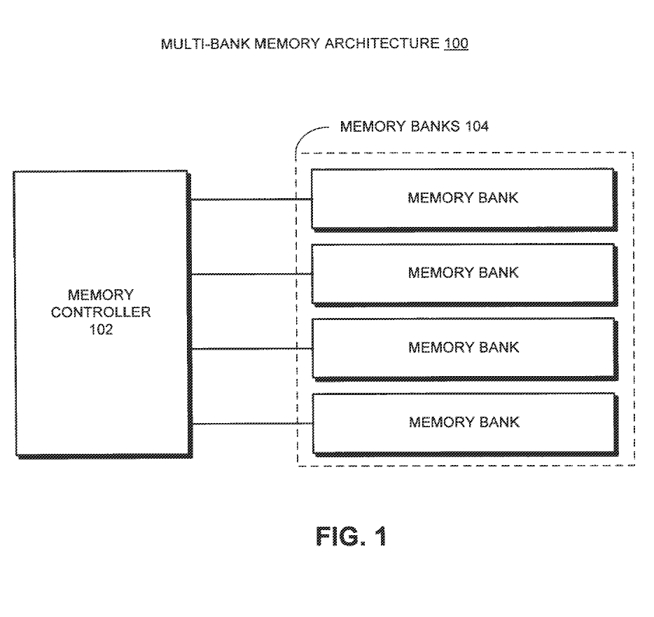

FIG. 1 presents a block diagram illustrating an embodiment of a multi-bank memory architecture 100. This memory architecture includes at least one memory controller 102 for controlling memory operations and one or more memory banks 104. While FIG. 1 illustrates memory architecture 100 having one memory controller 102 and four memory banks 104, other embodiments may have additional memory controllers and/or fewer or more memory banks 104. Note that memory controller 102 and memory banks 104 may be implemented on the same integrated circuit (IC) die. In other embodiments, they may be implemented on different integrated circuits which may be disposed within a single IC package, disposed in separate IC packages or implemented on bare integrated circuit dice.

Note that although memory controller 102 is illustrated as a single controller block in FIG. 1, memory controller 102 can be implemented in various embodiments for controlling memory operations on multiple memory banks 104.

For example, in some embodiments, memory controller 102 can further comprise a number of local bank controllers. In one embodiment, memory controller 102 can include four local bank controllers wherein each of the local bank controllers provides dedicated control functions to a respective memory bank 104. In another embodiment, memory controller 102 can include fewer local bank controllers than the number of memory banks. For example, memory controller 102 can include two local bank controllers, wherein each local bank controller provides dedicated control to a set of two of the four memory banks 104. Note that using local bank controllers can facilitate independent control of multiple local banks.

Furthermore, in some embodiments, memory controller 102 can comprise a global control circuitry in addition to a number of local bank controllers. In these embodiments, the global control circuitry can receive memory operations directly from a processor and can route the memory operations to different local bank controllers which provide control to the respective memory banks. Hence, the global control circuitry effectively manages control functions of the multiple local bank controllers.

We now describe in detail various embodiments of memory controller 102. In many of the variations discussed below, we assume that a single global control circuitry is used to manage one or more local bank controllers.

### Operation Control for Flash Memory Banks

In some embodiments, multi-bank memory architecture 100 can be applied to a multi-bank flash memory device. In these embodiments, memory banks 104 are flash memory banks, wherein each flash memory bank comprises flash memory cells (which are organized as addressable rows and columns) and associated circuits for accessing the cells (such as row decoders and a page buffer).

A memory controller within a flash memory device typically controls three types of operations on a given flash memory bank: read operations, program operations, and erase operations. Read operations are typically faster than the other two operations, and erase operations are typically the slowest of the three.

### Using Fully Dedicated Controls for Memory Banks

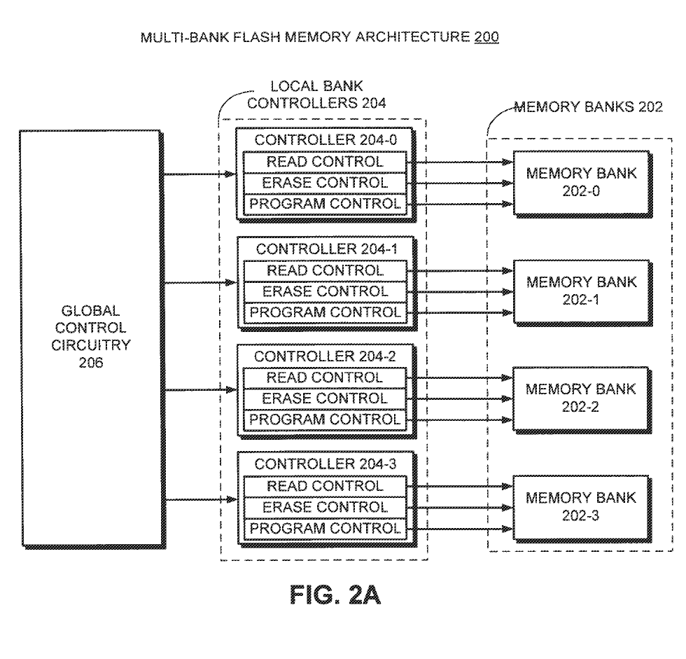

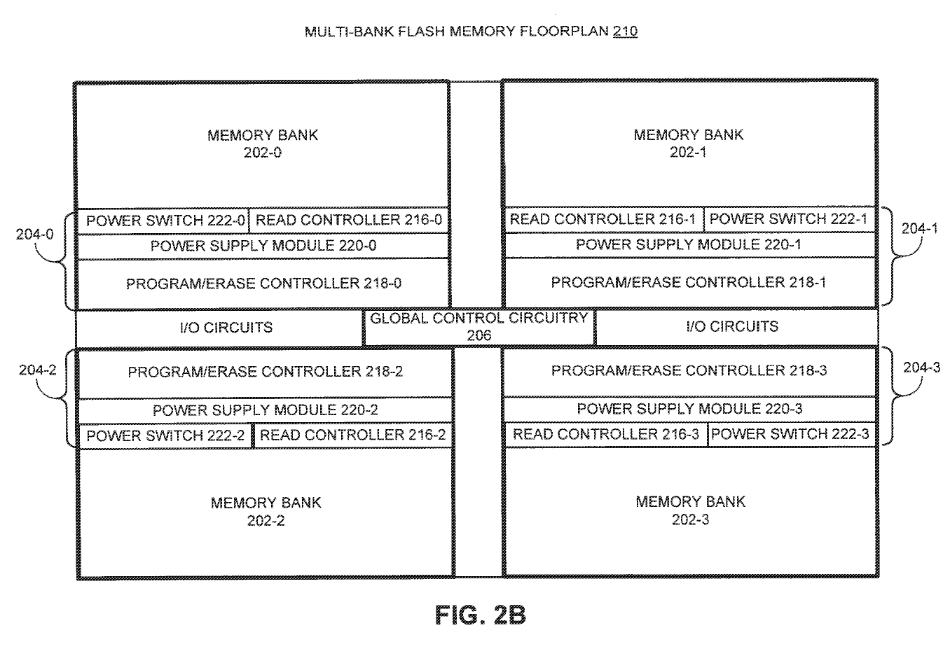

FIG. 2A illustrates an embodiment of a multi-bank flash memory architecture 200 wherein each memory bank is associated with a dedicated local bank controller. As shown in FIG. 2A, flash memory architecture 200 includes four memory banks 202-0, 202-1, 202-2, and 202-3. We collectively refer to the set of memory banks as “memory banks 202.” In other embodiments, flash memory device 200 can include fewer or more memory banks.

Note that each memory bank in FIG. 2A is associated with a dedicated local bank controller, i.e, local bank controllers 204-0, 204-1, 204-2, and 204-3 are associated with memory banks 202-0, 202-1, 202-2, and 202-3, respectively. We collectively refer to the set of local bank controllers as “local bank controllers 204.” Note that each of the local bank controllers 204 includes dedicated control functions for controlling read operations, program operations, and erase operations on the associated memory bank. Hence, each memory bank 202 can perform reading, programming, or erasing operations independently of other memory banks 202.

Additionally, multi-bank flash memory architecture 200 includes a global control circuitry 206 which is coupled to local bank controllers 204. In some embodiments, global control circuitry 206 coordinates multiple independent memory operations among local bank controllers 204.

FIG. 2B illustrates an exemplary integrated circuit (IC) chip floorplan 210 for the multi-bank flash memory architecture 200 illustrated in FIG. 2A. As seen in FIG. 2B, each of the four memory banks 202-0 to 202-3 is coupled to one of the four dedicated local bank controllers 204-0 to 204-3. For example, bank 202-0 in the first quadrant is interfaced with local bank controller 204-0. Note that each local bank controller 204 further includes a read controller 216 for controlling read operation on a respective bank 202, and a unified program/erase controller 218 for controlling both program and erase operations on the respective bank 202. In some embodiments, however, program control and erase control can be implemented through separate control modules within a local bank controller.

Each local bank controller 204 also includes power supply module 220 for providing operation voltages to the bank during a specific memory operation. Note that power supply module 220 can also include a voltage regulator circuit or a charge pump circuit. Note that charge pumps are typically used when bank operations require high voltages, in particular, during erase and program operations. Local bank controller 204 also includes a power switch 222, which couples power supply module 220 to the respective bank 202.

Note that in IC chip floorplan 210, global control circuitry 206 is located in a centralized region to facilitate interfacing with all four local bank controllers through the associated I/O circuits.

Note that the read control circuit, such as read controller 216-0, typically requires a smaller amount of control logic and hence occupies a smaller die area than other types of control circuits. In contrast, program and erase control circuits typically require more control logic and hence occupy a larger die area. In particular the program control circuit typically has the largest footprint among the three types of controllers. Although duplicating read/program/erase controls for each bank provides maximum flexibility, this duplication can increase chip size and manufacturing costs as the number of banks within a flash memory chip increases.

### Using Partially Dedicated Controls for Memory Banks

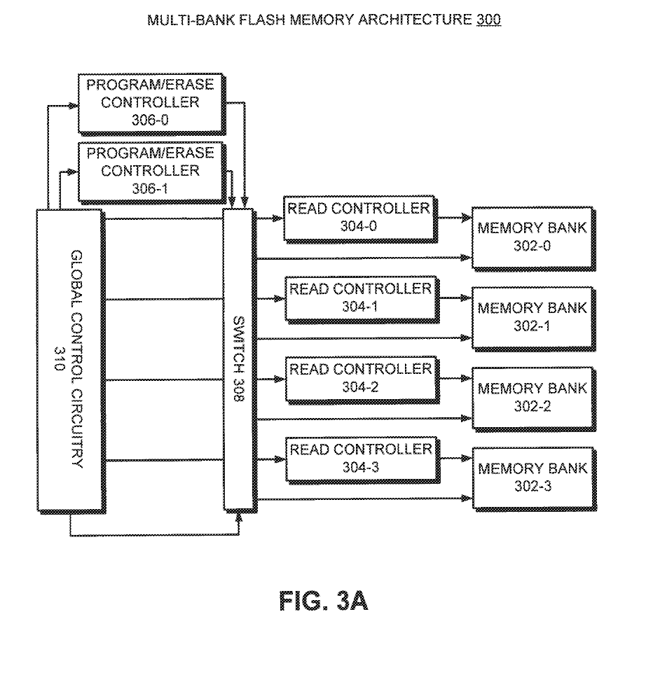

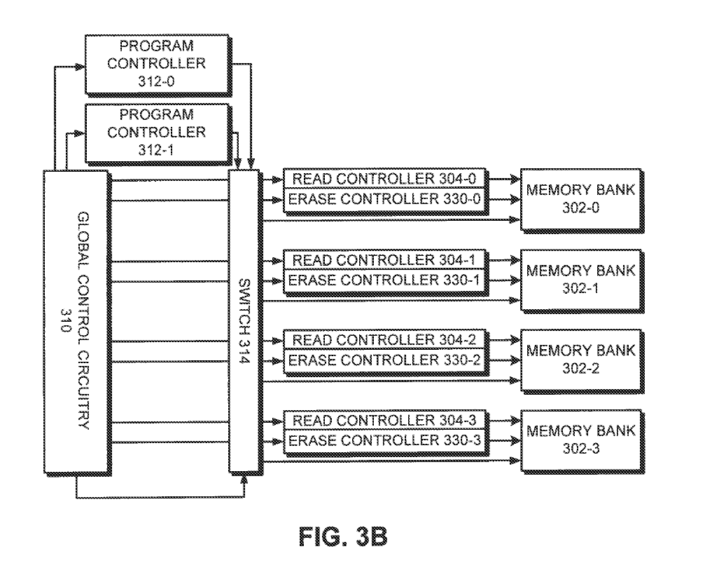

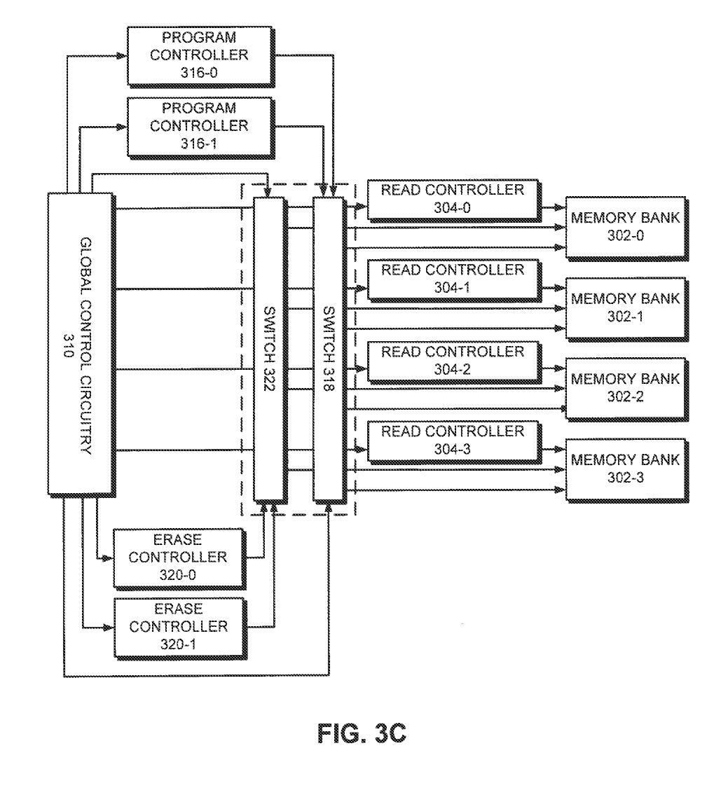

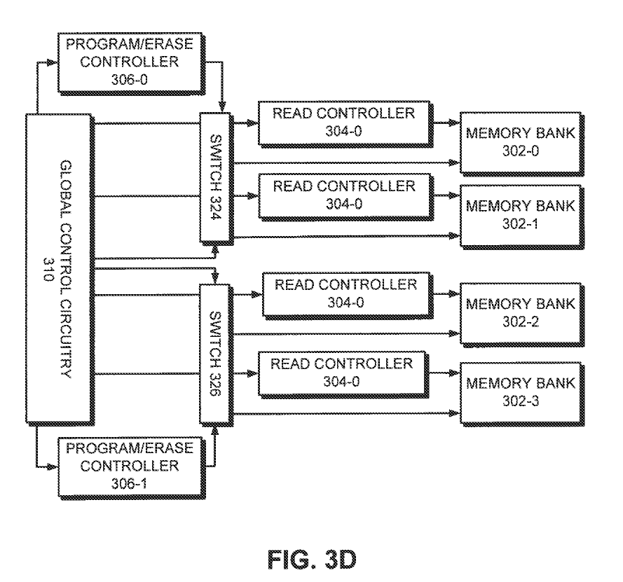

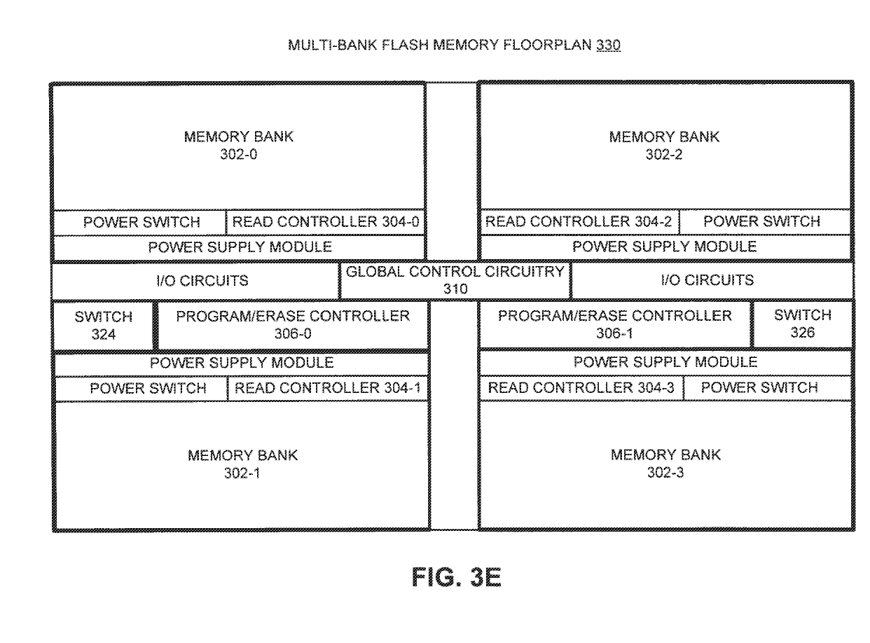

FIG. 3A illustrates an embodiment of a multi-bank flash memory architecture 300 using both shared control resources and dedicated local bank controllers. As illustrated in FIG. 3A, flash memory system 300 includes four memory banks 302-0, 302-1, 302-2, and 302-3. We collectively refer to the set of memory banks as memory banks 302. In other embodiments, flash memory architecture 300 can include fewer or more memory banks.

Note that each of the memory banks 302 in FIG. 3A is associated with a dedicated read controller 304-0, 304-1, 304-2, and 304-3 for controlling read operations on the associated memory bank. However, there are no dedicated program controllers or erase controllers associated with the memory banks. Instead, flash memory architecture 300 includes two sharable/assignable (referred simply as “sharable” hereafter) program/erase controllers 306-0 and 306-1 (referred to as “program/erase controllers 306” collectively) which are coupled to memory banks 302 through a switch 308. In this embodiment, each of the program/erase controllers 306 can be assigned to one of the memory banks 302 and can thereby enable both program and erase operations for memory bank 302. Note that switch 308 is configured so that each of the program/erase controllers 306 can be coupled to any of the memory banks 302. In one embodiment, switch 308 can include crossbar switches. Note that once assigned, there is a one-to-one correspondence between a sharable program/erase controller and a memory bank.

In some embodiments, each program/erase controller 306-0 or 306-1 can be concurrently assigned to multiple memory banks 302 to enable program and erase operations on these memory banks in parallel. Note that in these embodiments, there is a one-to-many correspondence between a single sharable program/erase controller and multiple memory banks 302.

While FIG. 3A illustrates two sharable memory controllers 306, other embodiments may have fewer or more instances of sharable/assignable memory controllers 306. Generally, however, the number of sharable/assignable memory controllers 306 is less than the number of memory banks 302. In one embodiment, a sharable program/erase controller 306 is assigned to a memory bank when the memory bank is required to perform a program or an erase operation. For example, program/erase controller 306-0 can be assigned to bank 302-3 to control a given erase operation. Meanwhile, program/erase controller 306-1 can be assigned to bank 302-1 to control a given program operation. While bank 302-1 and bank 302-3 independently perform program and erase operations, bank 302-0 and bank 302-2 can independently perform read operations under the control of dedicated read controllers 304.

Additionally, multi-bank flash memory architecture 300 includes a global control circuitry 310, which is coupled to both sharable program/erase controllers 306, switch 308, and read controllers 304. In one embodiment, global control circuitry 310 is configured to assign sharable controllers to the memory banks. More specifically, global control circuitry 310 is configured to assign a sharable controller to be exclusively used by a given memory bank. Furthermore, global control circuitry 310 is configured to coordinate read operations on the memory banks.

Because flash memory architecture 300 significantly reduces the number of program/erase control modules required to control multiple memory banks, the die size impact of program/erase controllers can be reduced. Meanwhile, read controllers (which typically require smaller chip die area) are replicated for each bank to provide maximum flexibility in read operations. Note that such a hierarchical control architecture facilitates a trade-off between bank flexibility and die size.

FIG. 3B illustrates a variation of the embodiment of the multi-bank flash memory architecture 300 illustrated in FIG. 3A. In this embodiment, each memory bank is associated with both a dedicated read controller 304-0, 304-1, 304-2, and 304-3, for controlling read operations, and a dedicated erase controller 330-0, 330-1, 330-2, and 330-3, for controlling erase operations on the associated memory bank. Hence, in this embodiment, the erase controls are not sharable as in FIG. 3A. However, there are no dedicated program controllers to the memory banks. Instead, there are two sharable program controllers 312-0 and 312-1 (referred to as “program controllers 312” collectively) which are coupled to memory banks 302 through a switch 314. Similar to the system of FIG. 3A, each of the program controllers 306 is assignable to any one of the memory banks 302.

In some embodiments, the decision about making a particular type of controller assignable or dedicated is based on size limitations on the associated control circuit. Note that a program controller generally has the largest amount of control logic and occupies the largest die area because of the state machine required to perform the program/verify iterations. Hence, making program controllers sharable significantly reduces the associated die size in comparison to the embodiment illustrated in FIG. 2. However, compared to the embodiment in FIG. 3A, the embodiment of FIG. 3B provides more bank control flexibility at the expense of larger die size.

FIG. 3C illustrates another variation of the embodiment of the multi-bank flash memory architecture 300 illustrated in FIG. 3A. In FIG. 3A, each of the sharable program/erase controllers 306 integrates the program control and erase control into a single shareable module. In contrast, in the embodiment illustrated in FIG. 3C, the program control and erase control are separate modules. More specifically, the embodiment of FIG. 3C includes two sharable program controllers 316-0 and 316-1 (referred to as “program controllers 316” collectively), which are coupled to memory banks 302 through a first switch 318, and two additional sharable erase controllers 320-0 and 320-1 (referred to as “erase controllers 320” collectively), which are coupled to memory banks 302 through a second switch 322. Note that, in this embodiment, program controls and erase controls are independently assignable to up to four memory banks, thereby increasing the bank control flexibility. For example, memory banks 302-0 and 302-1 can be performing program operations under the control of program controllers 316 while memory bank 302-2 is performing an erase operation under the control of erase controller 320-0, and memory bank 302-3 is performing a read operation under the control of a dedicated read controller 304-3.

FIG. 3D illustrates yet another variation of the embodiment of the multi-bank flash memory architecture 300 illustrated in FIG. 3A. Note that in FIG. 3A, each of the sharable program/erase controllers 306 is independently assignable to each of the four memory banks 302. Although this global assignability can maximize the utilization of each sharable resource, the design can be difficult to implement because a complicated switching mechanism is required. More importantly, in this embodiment, it is desirable to place both the sharable controllers and the switch at a centralized location due to a timing consideration. However, this layout may be difficult to implement because the global control circuitry already takes up space in the central region of the die. The design of FIG. 3D solves this problem by splitting the assignment of the sharable controllers. More specifically, the first sharable program/erase controller 306-0 is only coupled to a subset of memory banks 302-0 and 302-1 through a first switch 324, and is therefore assignable only to one of these memory banks. Separately, the second sharable program/erase controller 306-1 is only coupled to a subset of memory banks 302-2 and 302-3 through a second switch 326, and is therefore assignable only to one of these memory banks. We refer to this type of assignment configuration as “regional assignability” of sharable resources. Note that, in this embodiment, each of the program/erase controllers 306 can be located closer to the associated memory banks.

FIG. 3E illustrates an exemplary IC chip floorplan 330 for the multi-bank flash memory architecture illustrated in FIG. 3D. As illustrated in FIG. 3E, each of the four memory banks 302 is associated with a dedicated read controller 304. Moreover, sharable program/erase controller 306-0 (with highlighted border) is exclusively assignable to memory banks 302-0 and 302-1 on the left half of the chip plane, whereas sharable program/erase controller 306-1 (with highlighted border) is exclusively assignable to memory banks 302-2 and 302-3 on the right half of the chip plane. Flash memory 330 also includes a global control circuitry 310 which is located in a central region on the IC chip to facilitate communicating with both dedicated controllers and sharable controllers. Also note that switches 324 and 326 are shown in FIG. 3E next the respective sharable program/erase controller 306-0 and 306-1.

Note that FIGS. 3A-3D illustrate four possible embodiments that combine both dedicated control resources and sharable control resources within a multi-bank flash memory chip. Although there may be many other possible permutations for separating or combining the three control functions, such variations should be apparent to one of ordinary skill in the art. Hence, the present embodiments are not meant to be limited to the variations illustrated in FIGS. 3A-3D. For example, it is possible to combine the concepts of FIG. 3C and FIG. 3D by using separately assignable program controllers and erase controllers, wherein each controller is sharable by only a subset of the memory banks. In general, in all of these possible variations, some control functions are implemented through local bank controllers which are associated with particular memory banks, while other control functions are implemented through regionally or globally sharable controllers, which are assignable to more than one memory bank.

Note that in each of the above embodiments, the number of assignable controllers of a given type can be determined based on how many operations of a certain type may be performed simultaneously.

### Using All Assignable Controls for Memory Banks

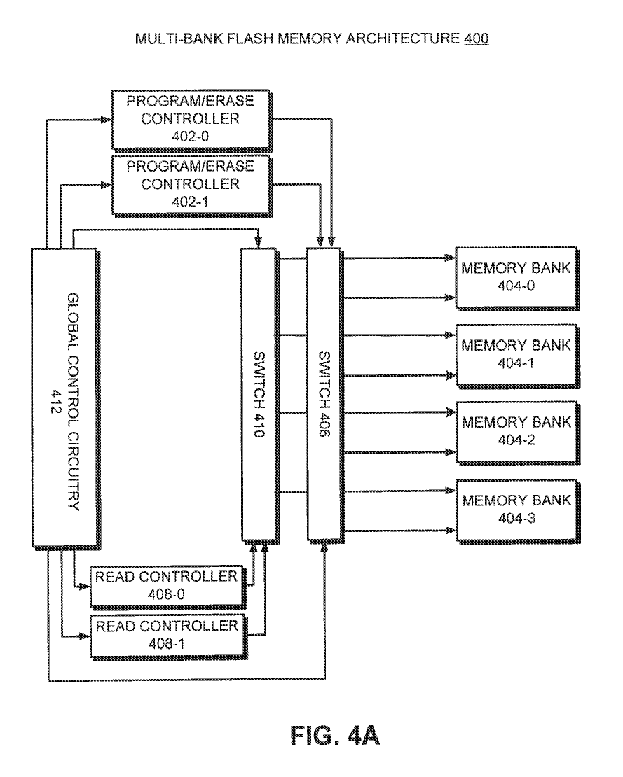

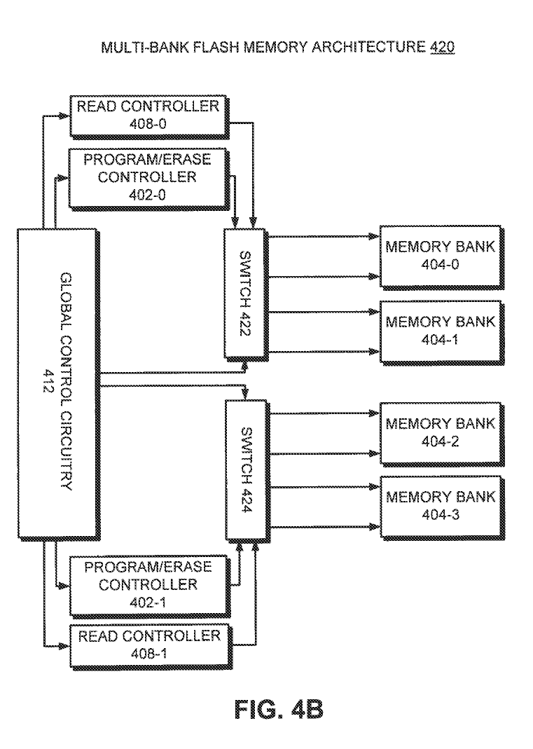

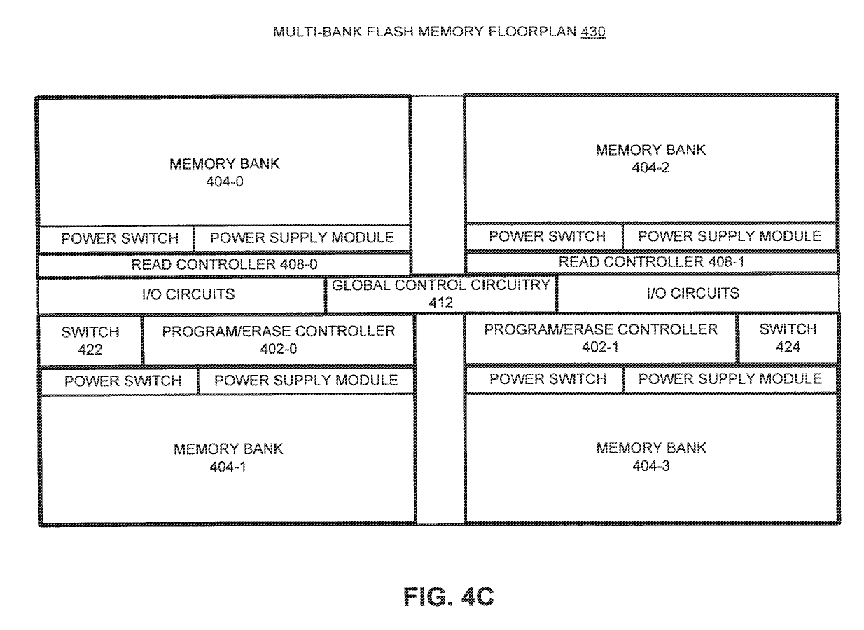

Note that the embodiments in FIG. 3A-3E all include at least one type of dedicated controller, for example dedicated read controllers. Note that to achieve maximum utilization of these dedicated controllers, all memory banks have to be performing the same operations concurrently, which may not be a likely scenario in some applications. In some embodiments, to further reduce the chip die size while improving control resource utilization, all control resources are made sharable and assignable. As shown in FIG. 4A, which is a variation of FIG. 3A, multi-bank flash memory architecture 400 includes two sharable program/erase controllers 402-0 and 402-1 (referred to as “program/erase controllers 402” collectively), which are coupled to four memory banks 404-0, 404-1, 404-2, and 404-3 (referred to as “memory banks 402” collectively) through a first switch 406. Moreover, multi-bank flash memory 400 also includes two sharable read controllers 408-0 and 408-1 (referred to as “read controllers 408” collectively), which are coupled to the four memory banks 404 through a second switch 410. Note that in this embodiment, each of the sharable controllers is assignable to any of the four memory banks.

While FIG. 4A illustrates two sharable program/erase controllers 402 and two sharable read controllers 408, other embodiments may have fewer or more instances of each type of memory controller. Generally, however, the number of each type of sharable memory controller is less than the number of memory banks 404. In one embodiment, a sharable program/erase controller 402 is assigned to a particular memory bank when that memory bank 404 is required to perform a program or an erase operation, while a sharable read controller 408 is assigned to another memory bank 404 when that memory bank is required to perform a read operation. Note that each memory bank 404 can perform an independent operation under control of one of the assignable memory controllers. Furthermore, different memory banks 404 can concurrently perform identical or different operations independently of each other under control of the assigned memory controllers.

Additionally, multi-bank flash memory 400 includes a global control circuitry 412 which is coupled to all sharable program/erase controllers 402 and sharable read controllers 408, and to switches 406 and 410. In one embodiment, global control circuitry 412 is configured to assign sharable controllers to the memory banks. Moreover, global control circuitry 412 is configured to assign a sharable controller to be exclusively used by a given memory bank.

FIG. 4B illustrates a multi-bank flash memory architecture 420, which is a variation of the embodiment of multi-bank flash memory architecture 400 illustrated in FIG. 4A. Note that in FIG. 4A, each sharable memory controller 402 or 408 is assignable to each of the four memory banks 404. Although this global assignability can maximize the utilization of each sharable resource, such a design can be difficult to implement due to a more complicated switching mechanism and floorplanning and timing considerations. The design illustrated in FIG. 4B solves this problem by splitting the assignment of each type of sharable controller. More specifically, sharable program/erase controller 402-0 and read controller 408-0 are only coupled to a subset of memory banks 404-0 and 404-1 through a first switch 422, and are therefore exclusively assignable to one of these memory banks. Separately, sharable program/erase controller 402-1 and read controller 408-1 are only coupled to a subset of memory banks 404-2 and 404-3 through a second switch 424, and are therefore exclusively assignable to one of these memory banks. Note that in this embodiment, each sharable memory controller can be located closer to the associated memory banks. In one embodiment, each switch 422 or 424 can be further split into two switches to couple each program/erase controller and read controller separately to the designated memory banks.

FIG. 4C illustrates an exemplary IC chip floorplan 430 for the multi-bank flash memory architecture illustrated in FIG. 4B. As seen in FIG. 4C, sharable program/erase controller 402-0 and read controller 408-0 (both are highlighted) are exclusively assignable to memory banks 404-0 and 404-1 on the left half of the chip plane, whereas sharable program/erase controller 402-1 and read controller 408-1 (both are highlighted) are exclusively assignable to memory banks 404-2 and 404-3 on the right half of the chip plane. Switches 422 and 424 are also placed in the respective half of the chip planes for selecting and coupling the respective sharable memory resources to the respective memory banks. Flash memory chip 430 also includes a global control circuitry 412 which is located in a central region on the IC chip to facilitate interfacing with all sharable controllers and the switches. Note that the design of chip 430 results in an even smaller chip size than the IC chip designs illustrated in FIG. 2B and FIG. 3E because this design facilitates more sharing of control resources.

Note that FIGS. 4A-4C illustrate two possible embodiments that provide assignable control resources within a multi-bank flash memory system. Although there may be a number of possible variations for separating or combining the three control functions, such variations will be apparent to one of ordinary skill in the art. Hence, the present embodiments are not meant to be limited to the types of variations illustrated in FIGS. 4A-4C. For example, one embodiment can use separately sharable program and erase controls, while another embodiment can use combined erase/read controls and independent program controls. In general, in all of these variations, control resources are sharable and assignable to more than one memory bank through one or more switches. Moreover, there can be other floorplan variations in terms of which memory banks a given sharable controller is applied to. For example, instead of assigning the left banks and right banks with separate sharable-controllers as shown in FIG. 4C, separate sharable-controllers can be assigned to upper banks and lower banks.

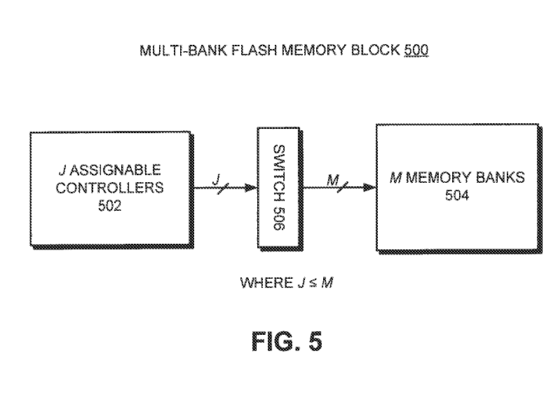

FIG. 5 illustrates a flash memory device 500 comprising a given type of assignable control resource and a set of associated memory banks. As illustrated in FIG. 5, a set of J assignable control resources 502 of a particular type is coupled to a set of M memory banks 504 through a switch 506. Note that each of the J assignable control resources can be assigned to each of the M memory banks 504. Also note that all of the J assignable control resources provide the same type of control function or the same type of combined control function. For example, control resources 502 can be a set of program controllers, a set of erase controllers, or a set of read controllers. Moreover, control resources 502 can be a set of combined erase/read controllers, a set of combined program/read controllers, or a set of combined program/erase controllers. Furthermore, control resources 502 can be a set of “all-in-one”program/erase/read controllers. In one embodiment, no matter what type of control function or functions are provided by control resources 502, the number J of the assignable control resources 502 is less than or equal to the number M of the memory banks that they can be assigned to, i.e., J≦M.

Note that flash memory device 500 as illustrated in FIG. 5 generalizes the relationship between a set of assignable control resources of a particular type and a set of memory banks that the set of control resources can be exclusively assigned to. Consequently, the flash memory device 500 is applicable to partially-dedicated-control designs, as illustrated in FIGS. 3A-3E, and all-assignable-control designs, as illustrated in FIGS. 4A-4C.

### Using a Single Global Controller

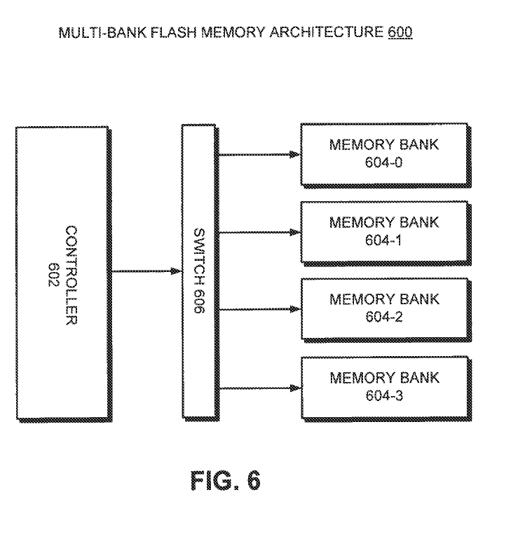

FIG. 6 illustrates a multi-bank flash memory architecture 600 using a single controller 602. In this embodiment, instead of using multiple sets of assignable controllers of various types, a single controller 602 is used to control all four memory banks 604-0, 604-1, 604-2, and 604-3 (referred to as “memory banks 604” collectively) through a switch 606.

More specifically, controller 602 provides all memory control functions (i.e., program, erase, and read) and can perform any control function on a given memory bank 604.

In some embodiments, controller 602 is assignable to only one of the memory banks 604 at a given time. In these embodiments, only one memory bank may be active at a given time. In other embodiments, controller 602 is assignable to more than one of the memory banks 604 at a given time to concurrently and independently control multiple memory banks 604 to perform desired bank operations. In these embodiments, controller 602 may further comprise multiple assignable memory controllers and a global control circuitry that manages these assignable memory controllers.

### Making Other Resources Sharable

Note that the general concept of making some resources within a multi-bank flash memory chip sharable and assignable is not limited to control resources. In some embodiments, non-controller resources within a multi-bank flash memory chip can be made sharable and assignable. For example, these non-controller resources can include a power supply circuit for the memory banks.

Referring back to FIG. 2B, note that each memory bank 202 is associated with a dedicated power supply module 220. In this embodiment, a power supply is always ready when the associated memory bank needs to perform a particular bank operation. On the other hand, a power supply is idle when the associated memory bank is not performing an operation. (Note that each power supply module may be configured differently for different operation modes. For example, higher supply voltage levels may be used during a program or erase operation than during a read operation.) Note that designs for these power supply modules may similarly balance the trade-off between bank flexibility and die size. In some embodiments, a smaller number of power supply modules can be made sharable and assignable among all memory banks.

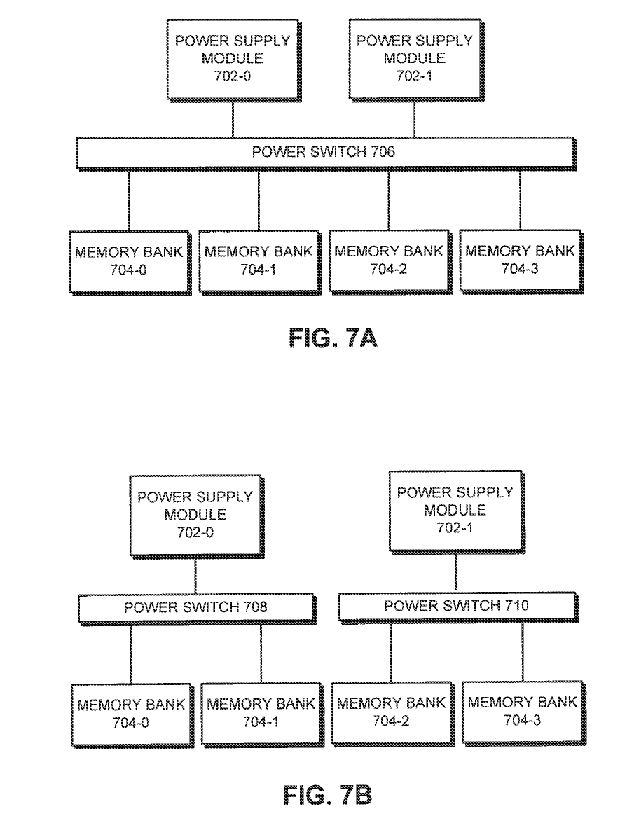

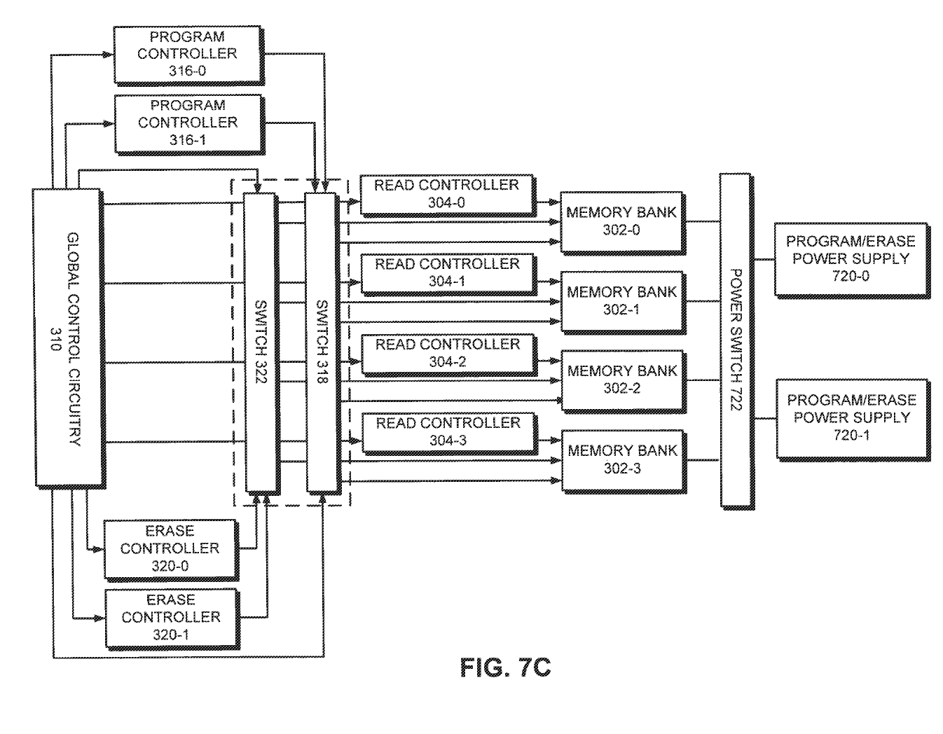

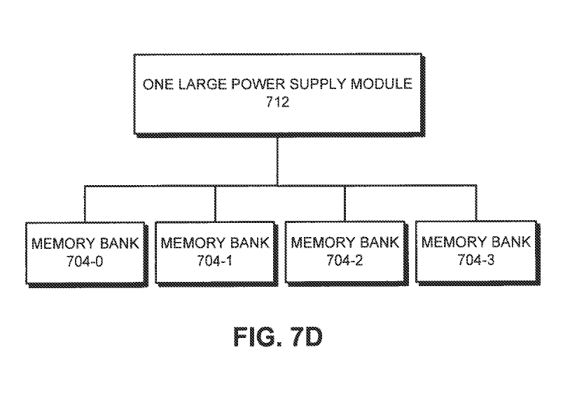

FIGS. 7A-7B illustrate a number of assignable power supply designs for a multi-bank flash memory chip. In these embodiments, we again consider four memory banks. However, other embodiments may have fewer or more memory banks. Note that in these embodiments no dedicated power supply modules are used.

FIG. 7A illustrates the use of fully assignable power supply modules to support a set of memory banks. Specifically, two sharable and assignable power supply modules 702-0 and 702-1 (referred to as “power supply modules 702” collectively) are coupled to four memory banks 704-0, 704-1, 704-2, and 704-3 (referred to as “memory banks 704” collectively) through a power switch 706. Generally, a power switch is configured to switch an input supply voltage between different outputs, which are coupled to different memory banks. In some embodiments, a power switch, such as power switch 706, may also include circuits for controlling the switching to avoid problems such as “snapback breakdown.”

While FIG. 7A illustrates two sharable power supply modules, other embodiments may have fewer or more shareable power supply modules. Generally, however, the number of sharable power supply modules 702 is less than the number of memory banks 704. In FIG. 7A, each sharable power supply module 702 is capable of supporting only one memory bank, and can be assigned to a particular memory bank 704 when that memory bank is required to perform an operation. Furthermore, both power supply modules 702 are assignable to any one of the memory banks 704.

Note that power supply modules 702 can include, but are not limited to a voltage regulator circuit or a charge pump circuit. Note that charge pumps are typically used when bank operations requires high voltages, in particular for the erase and program operations.

FIG. 7B illustrates the use of regionally assignable power supply modules to support a set of memory banks. Specifically, two sharable and assignable power supply modules 702-0 and 702-1 are coupled to four memory banks 704 through power switches 708 and 710, respectively. Note that while global assignability of FIG. 7A can maximize the utilization of each sharable power supply module, such a design can be difficult to implement due to a more complicated switching mechanism and floorplanning and timing considerations. The design of FIG. 7B solves this problem by splitting the association of each power supply module. More specifically, the first power supply module 702-0 is only coupled to a subset of memory banks 704-0 and 704-1 through the first power switch 708, and therefore is assignable exclusively to one of these memory banks. Separately, the second power supply module 702-1 is only coupled to a subset of memory banks 704-2 and 704-3 through the second power switch 710, and therefore is assignable exclusively to one of these memory banks. Note that in this embodiment, each power supply module can be located closer to the associated memory banks.

While FIG. 7B illustrates two sharable power supply modules, other embodiments may have fewer or more shareable power supply modules. Generally, however, the number of sharable power supply modules 702 is less than the number of memory banks 704. In the embodiment of FIG. 7B, each sharable power supply module 702 is capable of supporting a single associated memory bank. During operation, a sharable power supply module 702 can be assigned to one of the associated memory banks 704 when that memory bank is required to perform a bank operation. In one embodiment, power supply modules 702 can include, but are not limited to voltage regulator circuits and charge pump circuits. Note that charge pumps are typically used when bank operations require high voltages, in particular for the erase and program operations.

Note that in the embodiments illustrated in FIGS. 7A and 7B, each power supply module is configured to support all three operation modes, i.e., read, program, and erase operations. In some embodiments, separate power supply modules can be used for supporting different operation modes. For example, one embodiment uses read power-supply-blocks for read operations, program power-supply-blocks for program operations, and erase power-supply-blocks for erase operations. Another embodiment uses read power-supply-blocks for read operations and combined program/erase power-supply-blocks for both program and erase operations.

Note that when separate power supply modules are used to support different types of operation modes, each embodiment illustrated in FIG. 3 and FIG. 4 for the different controllers can be similarly applied to the power supply modules. For example, one embodiment can use dedicated read power-supply-blocks for supporting read operations on four associated memory banks 302, and use fewer sharable program/erase-power-supply blocks for supporting both program and erase operations on these memory banks. In another embodiment, two sharable read-power-supply-blocks are used to support read operations on memory banks 404, while two sharable program/erase-power-supply-blocks are used to support both program and erase operations on these memory banks. Note that it may be desirable to use combined program/erase power-supply-blocks and separate read power-supply blocks because the voltages used for program and erase operations are generally very similar but higher than the read voltages.

In some embodiments, the separate power supply modules can be configured to match the configuration of the controllers. For example, in a design which uses two assignable program/erase controllers, two corresponding assignable program/erase-power-supplies will be used in concert.

FIG. 7C illustrates an embodiment which combines the flash memory of FIG. 3C with separate assignable power supplies. More specifically, the embodiment of FIG. 7C includes separate assignable program controllers (316-0 and 316-1) and erase controllers (320-0 and 320-1). Additionally, the embodiment includes two assignable combined-program/erase-power-supplies 720-0 and 720-1 which are coupled to the memory banks 302 through power switch 722. Note that this embodiment facilitates performing a number of distinctive parallel operations on any two of the memory banks 302. For example, using the two program controllers, two erase controllers, and two program/erase power supplies, the flash memory can perform concurrently: (1) two program operations; (2) two erase operations; or (3) one program and one erase operation. Note that separate read power supplies are also used in the embodiment but are not shown in FIG. 7C.

FIG. 7D illustrates the use of a single assignable power supply module to support a set of memory banks. In this embodiment, instead of using multiple power supply modules, a single “large” power supply module 712, which is directly coupled to the memory banks, is used to support all four memory banks 704. In this embodiment, power supply module 712 is capable of simultaneously supporting all memory banks to perform concurrent bank operations. Note that in this embodiment, the design complexity is concentrated in the power supply module 712.

### SUMMARY

This disclosure has described embodiments of a nonvolatile memory that includes at least two concurrently accessible memory banks, each including nonvolatile memory cells. The nonvolatile memory further includes at least one sharable resource, wherein each sharable resource is assignable to at least two of the concurrently accessible memory banks to enable a first type of memory operation. The nonvolatile memory additionally includes a number of dedicated resources, wherein each dedicated resource is configured to enable a second type of memory operation on a specific bank within the concurrently accessible memory banks.

In some embodiments, the nonvolatile memory cells are NAND flash memory cells.

In some embodiments, the nonvolatile memory further includes a global control circuitry configured to assign the at least one sharable resource to the concurrently accessible memory banks.

In some embodiments, the global control circuitry is configured to assign a sharable resource to be exclusively used by a specific memory bank.

In some embodiments, the global control circuitry is configured to assign a sharable resource to be concurrently used by two or more of the memory banks.

In some embodiments, the at least one sharable resource is coupled to the at least two concurrently accessible memory banks through a switching circuit.

In some embodiments, the at least one sharable resource is coupled to a subset of the at least two concurrently accessible memory banks through a switching circuit.

In some embodiments, the sharable resource includes a bank controller for controlling the first type of memory operation. The first type of memory operation includes at least one of: a program operation on a memory bank; an erase operation on a memory bank; and a read operation on a memory bank.

In some embodiments, the dedicated resource includes a bank controller for controlling the second type of memory operation. The second type of memory operation includes at least one of: a program operation on a memory bank; an erase operation on a memory bank; and a read operation on a memory bank.

In some embodiments, the bank controller for controlling the first type of memory operation occupies a larger amount of die area than the bank controller for controlling the second type of memory operation.

This disclosure has described embodiments of another nonvolatile memory. This nonvolatile memory includes at least two concurrently accessible memory banks, each including nonvolatile memory cells. The nonvolatile memory further includes at least one sharable resource of a first type, wherein each sharable resource of the first type is assignable to at least two of the concurrently accessible memory banks to enable a first type of memory operation. The nonvolatile memory additionally includes at least one sharable resource of a second type, wherein each sharable resource of the second type is assignable to at least two of the concurrently accessible memory banks to enable a second type of memory operation.

In some embodiments, the nonvolatile memory cells are NAND flash memory cells.

In some embodiments, the nonvolatile memory further includes a global control circuitry configured to assign the at least one sharable resource of the first type and the at least one sharable resource of the second type to the concurrently accessible memory banks.

In some embodiments, the global control circuitry is configured to assign a sharable resource of the first type to be exclusively used by a specific memory bank.

In some embodiments, the global control circuitry is configured to assign a sharable resource of the first type to be concurrently used by two or more of the memory banks.

In some embodiments, the global control circuitry is configured to assign a sharable resource of the second type to be exclusively used by a specific memory bank.

In some embodiments, the global control circuitry is configured to assign a sharable resource of the second type to be concurrently used by two or more of the memory banks.

In some embodiments, the at least one sharable resource of a first type is coupled to the at least two concurrently accessible memory banks through a first switching circuit; and the at least one sharable resource of a second type is coupled to the at least two concurrently accessible memory banks through a second switching circuit.

In some embodiments, the at least one sharable resource of a first type is coupled to a subset of the at least two concurrently accessible memory banks through a first switching circuit; and the at least one sharable resource of a second type is coupled to a subset of the at least two concurrently accessible memory banks through a second switching circuit.

In some embodiments, the sharable resource of the first type includes a first bank controller for controlling the first type of memory operation. The first type of memory operation includes at least one of: a program operation on a memory bank; an erase operation on a memory bank; and a read operation on a memory bank.

In some embodiments, the sharable resource of the second type includes a second bank controller for controlling the second type of memory operation. The second type of memory operation includes at least one of: a program operation on a memory bank; an erase operation on a memory bank; and a read operation on a memory bank.

In some embodiments, the first bank controller occupies a different amount of die area than the second bank controller.

In some embodiments, the number of the sharable resources of the first type is less than or equal to the number of concurrently accessible memory banks in the nonvolatile memory. Furthermore, the number of the sharable resources of the second type is less than or equal to the number of concurrently accessible memory banks in the nonvolatile memory.

This disclosure has described embodiments of another nonvolatile memory. This nonvolatile memory includes at least two concurrently accessible memory banks, each including nonvolatile memory cells. The nonvolatile memory further includes at least one sharable resource, wherein each sharable resource is concurrently assignable to one or more of the concurrently accessible memory banks to enable a memory operation.

In some embodiments, the sharable resource includes a bank controller for controlling a memory operation, which include at least one of: a program operation on a memory bank; an erase operation on a memory bank; and a read operation on a memory bank.

In some embodiments, the sharable resource includes a power supply circuit for enabling the memory operation.

In some embodiments, the power supply circuit can include: a voltage regulator circuit; a charge pump circuit; and other power supply circuits.

In some embodiments, the power supply circuit includes one of: a program power-supply-block for enabling a program operation on a given memory bank; an erase power-supply-block for enabling an erase operation on a given memory bank; a read power-supply-block for enabling a read operation on a given memory bank; and a combined program/erase power-supply-block for enabling both program and erase operations on a given memory bank.

In some embodiments, the power supply circuit is coupled to the at least two concurrently accessible memory banks through a power-switching circuit.

In some embodiments, the power supply circuit is coupled to a subset of the at least two concurrently accessible memory banks through a power-switching circuit.

This disclosure has described embodiments of yet another nonvolatile memory. This nonvolatile memory includes at least two concurrently accessible memory banks, each including nonvolatile memory cells. The nonvolatile memory further includes a number of dedicated resources, wherein each dedicated resource is associated with a respective bank within the concurrently accessible banks to enable memory operations on the respective bank.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims

What is claimed is:

1-31. (canceled)

32. A non-volatile memory, comprising:
one or more memory subdivisions, wherein each memory subdivision includes non-volatile memory cells; and
a set of sharable resources that provide support for the one or more memory subdivisions;
wherein each sharable resource in the set of sharable resources can be assigned to a number of different memory subdivisions in the one or more memory subdivisions; and
wherein multiple sharable resources in the set of sharable resources that provide the same type of support are available to be assigned to each memory subdivision in the one or more memory subdivisions.

33. The non-volatile memory of claim 32, wherein each of the multiple sharable resources is to be dynamically assigned to support a memory transaction, such a first one of the multiple sharable resources is dynamically assigned to support a first memory transaction, and a second one of the multiple shareable resources is dynamically assigned to support a second, substantially concurrent memory transaction.

34. The non-volatile memory of claim 32, wherein the one or more memory subdivisions include one or more address ranges which comprise the non-volatile memory.

35. The non-volatile memory of claim 32, wherein the one or more memory subdivisions include one or more memory banks which comprise the non-volatile memory.

36. The non-volatile memory of claim 32, further comprising global control circuitry adapted to assign sharable resources to memory subdivisions.

37. The non-volatile memory of claim 36, wherein the global control circuitry is to temporarily assign a specific sharable resource for exclusive use by a specific memory subdivision.

38. The non-volatile memory of claim 36, wherein the global control circuitry is adapted to assign a sharable resource to be concurrently used by two or more memory subdivisions.

39. The non-volatile memory of claim 32, further comprising a switching circuit adapted to couple the set of sharable resources to the one or more memory subdivisions.

40. The non-volatile memory of claim 39, wherein the switching circuit is adapted to couple a given sharable resource in the set of sharable resources to a subset of the one or more memory subdivisions.

41. The non-volatile memory of claim 32, wherein a sharable resource in the set of sharable resources includes a first memory subdivision controller for controlling a first type of memory operation, wherein the first type of memory operation includes at least one of:
a program operation on a memory subdivision;
an erase operation on a memory subdivision; and
a read operation on a memory subdivision.

42. The non-volatile memory of claim 41, wherein a sharable resource in the set of sharable resources includes a second memory subdivision controller for controlling a second type of memory operation, wherein the second type of memory operation includes at least one of:
a program operation on a memory subdivision;
an erase operation on a memory subdivision; and
a read operation on a memory subdivision.

43. The non-volatile memory of claim 42, wherein the first memory subdivision controller occupies a larger amount of die area than the second memory subdivision controller.

44. The non-volatile memory of claim 32, wherein the sharable resource includes a power supply circuit to provide power to a memory subdivision.

45. The non-volatile memory of claim 44, wherein the power supply circuit can include:
a voltage regulator circuit;
a charge pump circuit; and
another type of power supply circuit.

46. The non-volatile memory of claim 44, wherein the power supply circuit includes one of:
a program power-supply-block for enabling a programming operation for a given memory subdivision;
an erase power-supply-block for enabling an erasing operation for a given memory subdivision;
a read power-supply-block for enabling a reading operation for a given memory subdivision; and
a combined program/erase power-supply-block for enabling both programming and erasing operations for a given memory subdivision.

47. The non-volatile memory of claim 32, wherein the non-volatile memory cells include NAND flash memory cells.

48. A non-volatile memory device, comprising:
a semiconductor die, wherein the semiconductor die includes circuitry which implements,
one or more memory subdivisions, wherein each memory subdivision includes non-volatile memory cells,
a set of sharable resources that provide support for the one or more memory subdivisions, and
wherein multiple sharable resources in the set of sharable resources that provide the same type of support are available to be assigned to each memory subdivision in the one or more memory subdivisions.

49. The non-volatile memory device of claim 48, wherein each of the multiple sharable resources is to be dynamically assigned to support a memory transaction, such a first one of the multiple sharable resources is dynamically assigned to support a first memory transaction, and a second one of the multiple shareable resources is dynamically assigned to support a second, substantially concurrent memory transaction.

50. The non-volatile memory device of claim 48, wherein each sharable resource in the set of sharable resources can be assigned to a number of different memory subdivisions in the one or more memory subdivisions.

51. The non-volatile memory device of claim 48, wherein the one or more memory subdivisions include one or more address ranges which comprise the non-volatile memory.

52. The non-volatile memory device of claim 48, wherein the one or more memory subdivisions include one or more memory banks which comprise the non-volatile memory.

53. The non-volatile memory device of claim 48, wherein a sharable resource in the set of sharable resources includes a memory subdivision controller for controlling a memory operation, wherein the memory operation includes at least one of:
a program operation on a memory subdivision;
an erase operation on a memory subdivision; and
a read operation on a memory subdivision.

54. The non-volatile memory device of claim 48, wherein the sharable resource includes a power supply circuit to provide power to a memory subdivision.

55. A non-volatile memory, comprising:
one or more memory banks, wherein each memory bank includes non-volatile memory cells;
a set of sharable controllers that control memory operations for the one or more memory banks;
a switching circuit adapted to couple the set of sharable controllers to the one or more memory banks; and
a global control circuit adapted to assign sharable controllers in the set of sharable controllers to memory banks in the set of memory banks;
wherein the switching circuit and the global control circuit are adapted so that,
each sharable controller in the set of sharable controllers can be assigned to a number of different memory banks in the one or more memory banks, and
multiple sharable controllers in the set of sharable controllers that control the same type of operation are available to be assigned to each memory bank in the one or more memory banks.

56. The non-volatile memory of claim 55, wherein each of the multiple sharable resources is to be dynamically assigned to support a memory transaction, such a first one of the multiple sharable resources is dynamically assigned to support a first memory transaction, and a second one of the multiple shareable resources is dynamically assigned to support a second, substantially concurrent memory transaction.

57. The non-volatile memory of claim 55, wherein a sharable controller in the set of sharable controllers is adapted to control at least one of:
a program operation on a memory bank;
an erase operation on a memory bank; and
a read operation on a memory bank.

58. A method for controlling a non-volatile memory, comprising:
receiving a request to perform a memory operation at the non-volatile memory, wherein the request is directed to a target memory subdivision in a set of memory subdivisions that comprise the non-volatile memory; and
directing the request to an assigned sharable controller in a set of sharable controllers, wherein the assigned sharable controller is assigned to control the memory operation for the target memory subdivision, and wherein multiple sharable controllers in the set of sharable controllers that control the same type of memory operation are available to be assigned to each memory subdivision in the set of memory subdivisions.

59. The method of claim 58, wherein each of the multiple sharable resources is to be dynamically assigned to support a memory transaction, such a first one of the multiple sharable resources is dynamically assigned to support a first memory transaction, and a second one of the multiple shareable resources is dynamically assigned to support a second, substantially concurrent memory transaction.

60. The method of claim 58, wherein the assigned sharable controller is adapted to control at least one of:
a program operation on a memory subdivision;
an erase operation on a memory subdivision; and
a read operation on a memory subdivision.

61. The method of claim 58, wherein the set of memory subdivisions includes one or more address ranges which comprise the non-volatile memory.

62. The method of claim 58, wherein the set of memory subdivisions includes one or more memory banks which comprise the non-volatile memory.
